(19) United States
(12) Patent Application Publication
(10) Pub. No.: US 2026/0092781 A1
(43) Pub. Date: Apr. 2, 2026

(54) METHOD AND SYSTEM TO ASSIST USER NAVIGATION WITHIN AN ENVIRONMENT

(71) Applicant: JPMorgan Chase Bank, N.A., New York, NY (US)

(72) Inventors: Aishwarya THAKUR, Hyderabad (IN); Hanumanthu PATHLAVATH, Nalgonda (IN); Nagababu JANNU, Vuyyuru (IN); Amit JAISWAL, Hyderabad (IN); Kiran PAMIDIMARRY, Glasgow (GB)

(73) Assignee: JPMorgan Chase Bank, N.A., New York, NY (US)

(21) Appl. No.: 19/345,941

(22) Filed: Sep. 30, 2025

(30) Foreign Application Priority Data
Oct. 1, 2024 (IN) 202411074328

(51) Int. Cl. G01C 21/00

(52) U.S. Cl. CPC G01C 21/005

(57) ABSTRACT

A method and system for assisting a user navigation within an environment are disclosed. The method includes receiving environmental data including at least a blueprint, and latest images of the environment. Next, the method includes receiving a navigation request from a user. Next, the method includes collecting image data and sensor data in real-time during a movement of the user within the environment. Next, the method includes analyzing, using a machine learning-based trained model, at least the environmental data, the image data, the sensor data, the source point, and the destination point to determine a navigational path for navigating the user to the destination point and to detect obstacles in the navigational path. The method includes providing navigation instructions to assist the user in navigating to the destination point, the navigation instructions being provided based on the determined navigational path and the obstacles detected in the navigational path.

### CROSS-REFERENCE TO RELATED APPLICATIONS

This application claims priority benefit from Indian Application No. 202411074328, filed on Oct. 1, 2024, in the India Patent Office, which is hereby incorporated by reference in its entirety.

### FIELD OF THE DISCLOSURE

This technology generally relates to image processing, and more particularly relates to a method and system to assist user navigation within an environment based on the image processing.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

People who are visually challenged look for ways to become more independent in their daily activities. They usually want to remove dependencies on others to perform their day-to-day activities. Due to various types of obstacles, abrupt and/or unexpected changes in the underlying walking surface (e.g., stairways, hills, potholes, etc.), as well as a variety of other potentially dangerous or disruptive situations (e.g., passing vehicles on road), visually impaired people have typically experienced limited mobility.

Accessibility and inclusivity in a workplace or office premises are crucial for creating a varied and productive atmosphere. However, those individuals with low-vision and blindness have a difficult time navigating office premises, spotting obstacles, and recognizing objects on their own. Such people often need assistance from other users. The lack of real-time information about obstacles, layout changes, and specific destinations within an office further complicates safe and efficient navigation. Static and dynamic obstacle detection, finding certain rooms (e.g., conference rooms, cabins, and washrooms) and people, safe navigation on the premises, and changes in office layouts are a few of the frequent difficulties faced by such people. These difficulties hinder the ability of such individuals to participate fully and independently in the workplace, which makes an impact on their productivity and integration.

Hence, in view of these and other existing limitations, there arises an imperative need to provide an efficient solution to overcome the above-mentioned limitations and to provide a method and system to efficiently provide real time navigation assistance for visually impaired people in complex indoor environments.

### SUMMARY

The present disclosure, through one or more of its various aspects, embodiments, and/or specific features or sub-components, provides, inter alias, various systems, servers, devices, methods, media, programs, and platforms to assist user navigation within an environment.

According to an aspect of the present disclosure, a method for assisting a user navigation within an environment is disclosed. The method is implemented by at least one processor. The method includes receiving, by the at least one processor, environmental data including at least a blueprint of the environment, and latest images of the environment Next, the method includes receiving, by the at least one processor, a navigation request from a user, the navigation request including a source point and a destination point within the environment. Next, the method includes collecting, by the at least one processor, image data and sensor data in real-time during a movement of the user within the environment, in response to the navigation request. Next, the method includes analyzing, by the at least one processor using a machine learning-based trained model, at least the environmental data, the image data, the sensor data, the source point, and the destination point to determine a navigational path for navigating the user from the source point to the destination point and to detect at least one obstacle in the navigational path. Next, the method includes providing, by the at least one processor, the navigation instructions to the user to assist the user in navigating to the destination point, the navigation instructions being provided based on the determined navigational path and the at least one obstacle detected in the navigational path.

In accordance with an exemplary embodiment, the image data may include a plurality of images of the environment captured, via a camera, in the real-time during the movement of the user from the source point to the destination point.

In accordance with an exemplary embodiment, the sensor data may include coordinates information associated with the user and the at least one obstacle detected during the movement of the user from the source point to the destination point.

In accordance with an exemplary embodiment, the sensor data may be received from at least one from among a plurality of sensors, wherein the plurality of sensors includes at least one from among a light detection and ranging (LiDAR) sensor, an ultrasonic sensor, a camera sensor, a microphone sensor, an accelerometer sensor, a gyroscope sensor, and a proximity sensor.

In accordance with an exemplary embodiment, to determine the navigational path, the method may further include comparing, by the at least one processor, the environmental data with the image data, the source point, and the destination point. Next, the method may further include determining, by the at least one processor, the navigational path based on a result of the comparing of the environmental data with the image data, the source point, and the destination point.

In accordance with an exemplary embodiment, the machine learning-based trained model may be trained using the environmental data to recognize a plurality of objects in the environment, identify a plurality of location areas in the environment, and identify a plurality of potential navigational paths between at least one potential source point and at least one potential destination point in the environment.

In accordance with an exemplary embodiment, the navigation instructions may be provided to the user via audio commands.

According to another aspect of the present disclosure, a computing device configured to implement an execution of a method for assisting a user navigation within an environment is disclosed. The computing device includes a processor; a memory storing instructions; and a communication interface coupled to each of the processor and the memory. The processor may be configured to cooperate with the instructions to perform operations including: receiving environmental data including at least a blueprint of the environment, and latest images of the environment; receiving a navigation request from a user, the navigation request including a source point and a destination point within the environment; collecting image data and sensor data in real-time during a movement of the user within the environment, in response to the navigation request; analyzing, using a machine learning-based trained model, at least the environmental data, the image data, the sensor data, the source point, and the destination point to determine a navigational path for navigating the user from the source point to the destination point, to detect at least one obstacle in the navigational path; and providing the navigation instructions to the user to assist the user in navigating to the destination point, the navigation instructions being provided based on the determined navigational path and the at least one obstacle detected in the navigational path.

In accordance with an exemplary embodiment, the image data may include a plurality of images of the environment captured, via a camera, in the real-time during the movement of the user from the source point to the destination point.

In accordance with an exemplary embodiment, the sensor data may include coordinates information associated with the user and the at least one obstacle detected during the movement of the user from the source point to the destination point.

In accordance with an exemplary embodiment, the sensor data may be received from at least one from among a plurality of sensors, wherein the plurality of sensors includes at least one from among a light detection and ranging (LiDAR) sensor, an ultrasonic sensor, a camera sensor, a microphone sensor, an accelerometer sensor, a gyroscope sensor, and a proximity sensor.

In accordance with an exemplary embodiment, to determine the navigational path, the processor may be further configured to cooperate with the instructions to perform operations including comparing the environmental data with the image data, the source point, and the destination point, and determining the navigational path based on a result of the comparing of the environmental data with the image data, the source point, and the destination point.

In accordance with an exemplary embodiment, the machine learning-based trained model may be trained using the environmental data to recognize a plurality of objects in the environment, identify a plurality of location areas in the environment, and identify a plurality of potential navigational paths between at least one potential source point and at least potential one destination point in the environment.

In accordance with an exemplary embodiment, the navigation instructions may be provided to the user via audio commands.

According to yet another aspect of the present disclosure, a non-transitory computer-readable storage medium storing instructions for assisting a user navigation within an environment is disclosed. The instructions include executable code which, when executed by a processor, may cause the processor to perform operations including: receiving environmental data including at least a blueprint of the environment, and latest images of the environment; receiving a navigation request from a user, the navigation request including a source point and a destination point within the environment; collecting image data and sensor data in real-time during a movement of the user within the environment, in response to the navigation request; analyzing, using a machine learning-based trained model, at least the environment data, the image data, the sensor data, the source point, and the destination point to determine a navigational path for navigating the user from the source point to the destination point, and to detect at least one obstacle in the navigational path; and providing the navigation instructions to the user to assist the user in navigating to the destination point, the navigation instructions being provided based on the determined navigational path and the at least one obstacle detected in the navigational path.

In accordance with an exemplary embodiment, the image data may include a plurality of images of the environment captured via a camera, in real-time during the movement of the user from the source point to the destination point.

In accordance with an exemplary embodiment, the sensor data may include coordinates information associated with the user and the at least one obstacle detected during the movement of the user from the source point to the destination point.

In accordance with an exemplary embodiment, the sensor data may be received from at least one from among a plurality of sensors, wherein the plurality of sensors includes at least one from among a light detection and ranging (LiDAR) sensor, an ultrasonic sensor, a camera sensor, a microphone sensor, an accelerometer sensor, a gyroscope sensor, and a proximity sensor.

In accordance with an exemplary embodiment, to determine the navigational path, the processor may perform operations further including comparing the environmental data with the image data, the source point, and the destination point, and determining the navigational path based on a result of the comparing of the environmental data with the image data, the source point, and the destination point.

In accordance with an exemplary embodiment, the machine learning-based trained model may be trained using the environmental data to recognize a plurality of objects in the environment, identify a plurality of location areas in the environment, and identify a plurality of potential navigational paths between at least one potential source point and at least one potential destination point in the environment.

In accordance with an exemplary embodiment, the navigation instructions may be provided to the user via audio commands.

### BRIEF DESCRIPTION OF THE DRAWINGS

The present disclosure is further described in the detailed description which follows, about the noted plurality of drawings, by way of non-limiting examples of exemplary embodiments of the present disclosure, in which like characters represent like elements throughout the several views of the drawings.

FIG. 1 illustrates an exemplary computer system to assist a user navigation within an environment, in accordance with an exemplary embodiment of the present disclosure.

FIG. 2 illustrates an exemplary diagram of a network environment to assist a user navigation within an environment, in accordance with an exemplary embodiment of the present disclosure.

FIG. 3 illustrates an exemplary system to assist a user navigation within an environment, in accordance with an exemplary embodiment of the present disclosure.

FIG. 4 illustrates an exemplary method flow diagram to assist a user navigation within an environment, in accordance with an exemplary embodiment of the present disclosure.

FIG. 5 illustrates an architecture of a system to assist a user navigation within an environment, in accordance with an exemplary embodiment of the present disclosure.

FIG. 6 illustrates an architecture of a system depicting cloud-based image processing to assist a user navigation within an environment, in accordance with an exemplary embodiment of the present disclosure.

FIG. 7 illustrates a process flow to assist a user navigation within an environment, in accordance with an exemplary embodiment of the present disclosure.

FIG. 8 illustrates a process for identifying walkable paths to assist a user to navigate within an environment, in accordance with an exemplary embodiment of the present disclosure.

FIG. 9 illustrates a user interface of the navigation application depicting navigation inside the office environment, in accordance with an exemplary embodiment of the present disclosure.

FIG. 10 illustrates a user interface of the navigation application depicting navigation outside the office environment, in accordance with an exemplary implementation.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

Currently, there is a notable absence of systems or products that offer comprehensive and precise assistance for individuals in workplace environments. While various assistive technologies exist for visually impaired individuals in general navigation scenarios, they often fall short when applied to complex workplace settings. These environments present unique challenges such as navigating through cubicles, finding specific office rooms or equipment, and safely maneuvering around dynamic workplace hazards. Existing solutions typically lack the detailed mapping, real-time updates, and context-awareness required to effectively guide individuals in such environments. As a result, there remains a significant gap in providing visually impaired workers with the tailored, reliable assistance they need to navigate and perform tasks confidently in their workplace (e.g., office premises).

The present disclosure solves the aforementioned problems by providing a method and system for assisting a user navigation within an environment. In the present disclosure, at first, the system receives environmental data including at least a blueprint of the environment, and latest images of the environment. Further, the system receives a navigation request from a user, the navigation request including a source point and a destination point within the environment. Further, the system collects image data and sensor data in real-time during a movement of the user within the environment, in response to the navigation request. Further, the system analyzes, using a machine learning-based trained model, at least the environmental data, the image data, the sensor data, the source point, and the destination point to determine a navigational path for navigating the user from the source point to the destination point, and to detect one or more obstacles in the navigational path. Thereafter, the system provides navigation instructions to the user to assist the user in navigating from the source point to the destination point, where the navigation instructions may be provided based on the determined navigational path and the obstacle(s) detected in the navigational path.

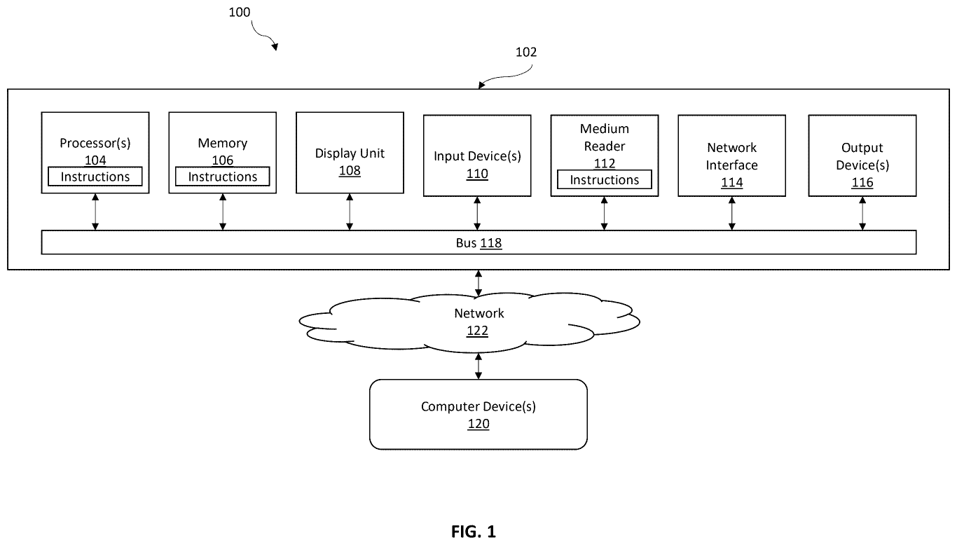

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specification.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specification.

Each of the components of the computer system 102 may be interconnected and communicate via a bus 118 or other communication link. As shown in FIG. 1, the components may be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems to assist a user navigation within an environment.

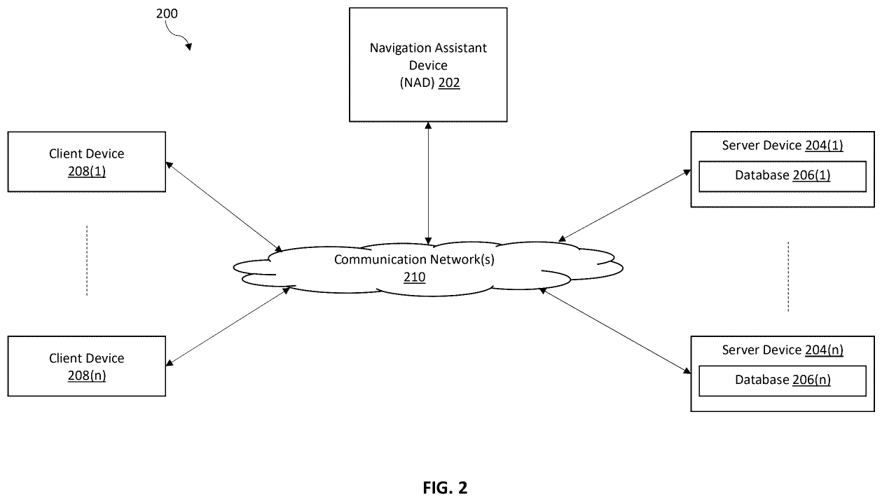

Referring to FIG. 2, a schematic of an exemplary network environment 200 to assist user navigation within an environment is illustrated. In an exemplary embodiment, the method is executable on any networked computer platform, such as, for example, a personal computer (PC).

The method to assist user navigation within an environment may be executed by a navigation assistant device (NAD) 202. The NAD 202 may be the same or similar to the computer system 102 as described with respect to FIG. 1. The NAD 202 may store one or more applications that may include executable instructions that, when executed by the NAD 202, cause the NAD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the NAD 202 itself, may be located in the virtual server(s) running in a cloud-based computing environment rather than being tied to one or more specific physical network computing devices. Also, the application(s) may be running in one or more virtual machines (VMs) executing on the NAD 202. Additionally, in one or more embodiments of this technology, virtual machine(s) running on the NAD 202 may be managed or supervised by a hypervisor.

In the network environment 200 of FIG. 2, the NAD 202 is coupled to a plurality of server devices 204(1)-204(n) that hosts a plurality of databases 206(1)-206(n), and also to a plurality of client devices 208(1)-208(n) via communication network(s) 210. A communication interface of the NAD 202, such as the network interface 114 of the computer system 102 of FIG. 1, operatively couples and communicates between the NAD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the NAD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and NADs that efficiently implement the method to assist user navigation within an environment.

By way of example only, the communication network(s) 210 may include local area network(s) (LAN(s)) or wide area network(s) (WAN(s)), and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), public switched telephone networks (PSTNs), ethernet-based packet data networks (PDNs), combinations thereof, and the like.

The NAD 202 may be a standalone device or integrated with one or more other devices or apparatuses, such as one or more of the server devices 204(1)-204(n), for example. In one particular example, the NAD 202 may include or be hosted by one of the server devices 204(1)-204(n), and other arrangements are also possible. Moreover, one or more of the devices of the NAD 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the NAD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to blueprints or layouts of an environment and a plurality of navigation instructions.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the NAD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the NAD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the NAD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the NAD 202, the server devices 204(1)-204(n), or the client devices 208(1)-208(n), for example, may be configured to operate as virtual instances on the same physical machine. In other words, one or more of the NAD 202, the server devices 204(1)-204(n), or the client devices 208(1)-208(n) may operate on the same physical device rather than as separate devices communicating through communication network(s) 210. Additionally, there may be more or fewer NADs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, packet data networks (PDNs), the Internet, intranets, and combinations thereof.

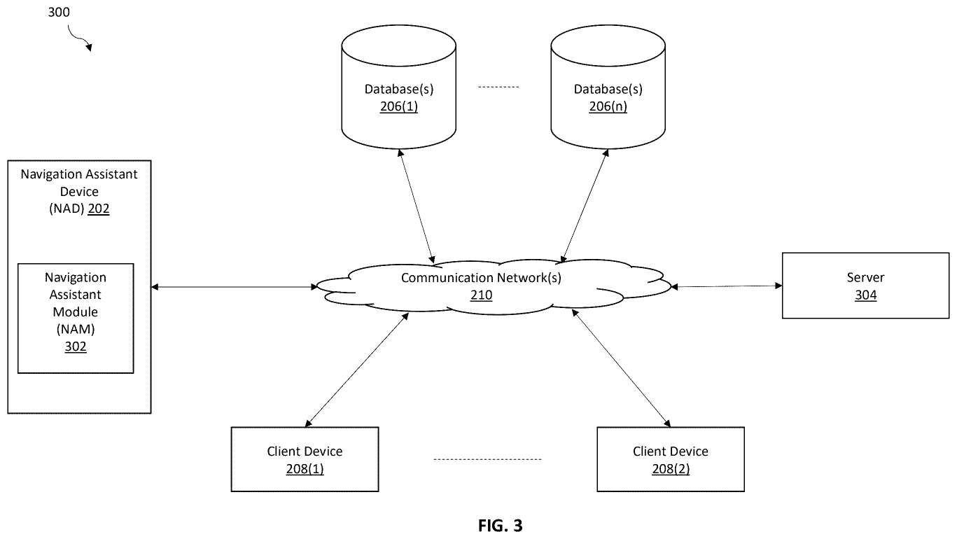

FIG. 3 illustrates a system diagram for implementing a method to assist a user navigation within an environment, in accordance with an exemplary embodiment.

As illustrated in FIG. 3, the system 300 may include a NAD 202 within which a navigation assistant module (NAM) 302 is embedded, a server 304, a database(s) 206(1) . . . 206(n), a plurality of client devices 208(1) . . . 208(2), and a communication network(s) 210.

According to exemplary embodiments, the NAD 202 including the NAM 302 may be connected to the server 304, and the database(s) 206(1) . . . 206(n) via the communication network(s) 210, but the disclosure is not limited thereto. The NAD 202 may also be connected to the plurality of client devices 208(1) . . . 208(2) via the communication network 210, but the disclosure is not limited thereto. The database(s) 206(1) . . . 206(n) may include a rules database.

In an embodiment, the NAD 202 is described and shown in FIG. 3 as including the NAM 302, although it may include other rules, policies, modules, databases, or applications, for example. As will be described below, the NAM 302 is configured to implement a method to assist the user navigation within an environment.

An exemplary system 300 for implementing a mechanism to assist the user navigation within an environment by utilizing the network environment of FIG. 2 is shown as being executed in FIG. 3. Specifically, a first client device 208(1) and a second client device 208(2) are illustrated as being in communication with the NAD 202. In this regard, the first client device 208(1) and the second client device 208(2) may be “clients” of the NAD 202 and are described herein as such. Nevertheless, it is to be known and understood that the first client device 208(1) and/or the second client device 208(2) need not necessarily be “clients” of the NAD 202, or any entity described in association therewith herein. Any additional or alternative relationship may exist between either or both of the first client device 208(1) and the second client device 208(2) and the NAD 202, or no relationship may exist.

Further, the NAD 202 is illustrated as being able to access one or more databases 206(1) . . . 206(n). The NAM 302 may be configured to access these repositories/databases for implementing a method to assist user navigation within an environment. In some embodiments, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the NAD 202 via broadband or cellular communication. These embodiments are merely exemplary and are not limiting or exhaustive.

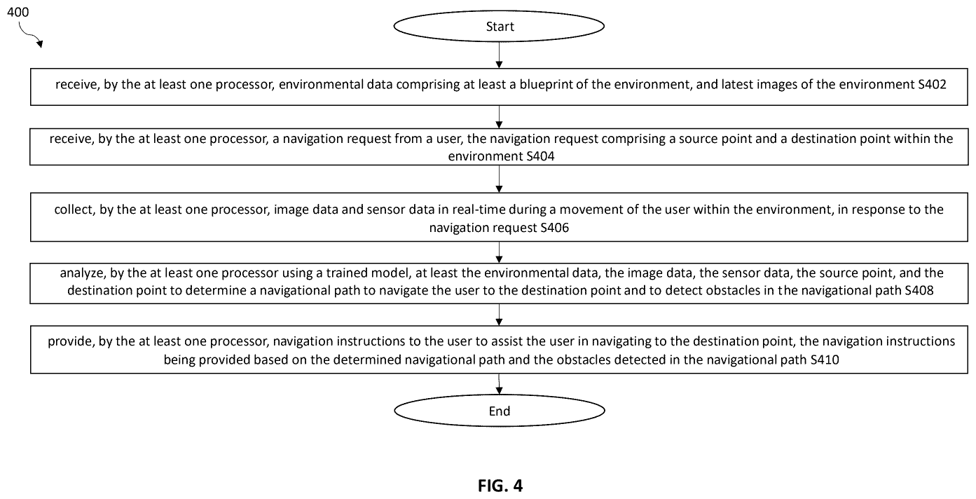

Referring to FIG. 4, an exemplary method 400 is shown to assist a user navigation within an environment, in accordance with an exemplary implementation.

As shown in FIG. 4, the method 400 begins following a need to provide navigation guidance or assistance for individuals in order to assist them in navigating spaces such as in an office environment. The method 400 is implemented by at least one processor 104.

At step S402, the method 400 includes receiving, by the at least one processor 104, environmental data including at least a blueprint of the environment, and latest images of the environment.

In an exemplary implementation, the environmental data may be stored in a database. The environment may be an office premises, any public space, an indoor space, or an outdoor space. In an exemplary implementation, the database acts as a central repository and the database may communicably coupled with a server. It may be to be noted that the blueprints may be used to identify the structure or layout of the environment.

The term “blueprints” herein may correspond to detailed plans or designs that outline the structure or layout of a space or environment. The update in blueprints corresponds to an update in the digital map of the environment to reflect any changes in a layout or obstacles in such environment.

The latest images of the environment correspond to updated images of the environment that represent any update or change in the structure of the environment. For example, the latest images of the environment may be captured using a plurality of preinstalled cameras within the environment. In an exemplary implementation, a plurality of internet of things (IoT) devices may be utilized to monitor and communicate real-time changes in the environment.

In an exemplary implementation, the latest images of the environment may be received from a minimal group of employees through their portable devices. The latest images of the environment may also be received from actual end users of such devices in order to update the environment data and make it more accurate.

In an exemplary implementation, the method includes fetching, by the at least one processor 104, the blueprints from at least one external source belonging to the environment or an organization. The at least one external source may be selected from, but not limited to, any one or more of a server, a cloud server, and at least one database. The server may be connected with the at least one processor 104 via a communication network. The communication network may be an Internet-based network.

It will be appreciated by the person skilled in the art that the aim here is to create a system that provides navigation instruction(s) over the application to assist the user in navigating places in the environment.

At step S404, the method includes receiving, by the at least one processor 104, a navigation request from a user, the navigation request including a source point and a destination point within the environment.

In an exemplary implementation, the navigation request may be raised by the user using an application (e.g., a web application or a mobile application). The application may be installed on a user device (e.g., a device operated by the user). The user device may be selected from at least one from among a smartphone, a laptop, a tablet, and a computer. The navigation request may include the source point (also referred to as a starting point), and a destination point (also referred to as an end point). The navigation request may be received via an audio input. For example, a visually impaired user may use voice command or audio command, via a microphone of the user device, to request the navigation from point A to point B in the office premises.

The term “application” herein may correspond to a software program or tool that may be designed to receive input from the user and provide output to the user.

The term “web application” herein may correspond to a webpage of the application that may run in a web browser, accessed over the internet, and may not require installation on the user's device.

In an example, in case the application installed in the user device may not be working, the user may request navigation from the source point to the destination point by accessing the web application over the internet.

At step S406, the method includes collecting, by the at least one processor 104, image data and sensor data in real-time during a movement of the user within the environment, in response to the navigation request.

The image data may include a plurality of images of the environment captured, via a camera unit (also referred to as a camera), in the real-time during the movement of the user from the source point to the destination point.

The sensor data may include coordinates information associated with the user and one or more obstacles detected during the movement of the user from the source point to the destination point. The sensor data may be received from at least one of a plurality of sensors. The plurality of sensors may include at least one from among a light detection and ranging (LiDAR) sensor, an ultrasonic sensor, a camera sensor, a microphone sensor, an accelerometer sensor, a gyroscope sensor, and a proximity sensor. Coordinate information may refer to a set of numerical values that represent the spatial positions of various elements within an environment. The coordinate information may include spatial coordinates. Spatial coordinates may include numerical values that represent specific positions or locations within a defined space. The spatial coordinates may include latitude, longitude, cartesian coordinates, and/or geospatial coordinates. For example, the plurality of sensors may be used to determine the position of the user, detect the presence of one or more obstacles, measure a distance between the user and the one or more obstacles, and identify the type(s) of the one or more obstacles during the movement of the user.

In an exemplary implementation, the method may include collecting, by the processor 104, the coordinate information with at least one-meter radius (1M) radius for each point of interest (POI) label or obstacle, from the sensor data. The coordinate information (e.g., the spatial coordinates) may be used by a machine learning-based trained model or a geospatial model to facilitate navigation assistance to the user. The machine learning-based trained model may be trained using algorithms such as convolutional neural network (CNN) algorithms, natural language processing algorithms, and reinforcement learning algorithms.

In an exemplary implementation, the camera unit may be operationally coupled to a device (e.g., a badge attached over an identity (ID) card) carried by end user(s). The image data captured during the movement of the user across the environment may be transmitted to the at least one processor 104 through the application. The device may include at least one from among a 360-degree camera sensor, a memory unit, a communication unit, a microphone, and a vibration output.

In an exemplary implementation, the method may include loading, by the processor 104, the image data received from the application in the database for preprocessing of the image data.

At step S408, the method includes analyzing, by the at least one processor 104, using a machine learning-based trained model, at least the environmental data, the image data, the sensor data, the source point, and the destination point to determine a navigational path to navigate the user from the source point to the destination point and to detect one or more obstacles in the navigational path.

The machine learning-based trained model may be trained using the environmental data to recognize a plurality of objects in the environment, identify a plurality of location areas in the environment, and identify a plurality of potential navigational paths between at least one potential source point and at least one potential destination point in the environment. For example, the model may be trained using algorithms on a set of data associated with images of an office premises, layout and floor plan of the office, blueprint of the office structure, and the like. Further, the machine learning-based trained model may be trained to recognize various objects within the environment such as the office environment.

In an exemplary implementation, the method may include processing, by the at least one processor 104, the environmental data and the image data to retrieve features for identifying objects in the environment. The features may include distinct and informative aspects or characteristics extracted from the images. The features may include at least one from among, geometric properties of objects, such as the size, orientation, contour shape, and classifications of objects or scenes within an image. The processing of the plurality of images may be performed using computer vision algorithms. The computer vision algorithms may include at least one from among convolutional neural networks (CNNs), you only look once (YOLO) algorithms, A* Search algorithm, Dijkstra's algorithms, recurrent neural networks (RNNs), and/or natural language processing (NLP) algorithms. These algorithms may be instrumental in analyzing interfaces, identifying visual elements, and processing content for potential barriers. The at least one processor 104 may apply A* search algorithm or Dijkstra's algorithms over the environmental data, the image data, the sensor data, the source point, and the destination point to find an optimal navigational path from the user's current location to the destination point while considering factors like distance, accessibility, and user preferences.

At step S410, the method includes providing, by the at least one processor 104, the navigation instructions to the user to assist the user in navigating to the destination point. The navigation instructions may be provided based on the determined navigational path and the one or more obstacles detected in the navigational path. The navigation instructions may be provided to the user via audio commands.

To determine the navigational path, the method may include comparing, by the at least one processor 104, the environmental data with the image data, the source point, and the destination point. The method may further include determining, by the at least one processor 104, the navigational path based on a result of the comparison of the environmental data with the image data, the source point, and the destination point.

In an exemplary implementation, comparing the environmental data may include matching, by the at least one processor 104, the features detected in the image data with features detected in the previously acquired images of the environment to facilitate tracking movements of the user in the environment. For example, the navigational path may be found by analyzing spatial relationships and distances between the user's location received from the sensor data and the destination point, leveraging the knowledge stored in the database.

In an exemplary implementation, the method may include providing, by the at least one processor 104 to the application, the navigation instructions for the user to navigate the user to the destination point. The navigation instructions may be provided to the user via the audio commands through the application. The application may be configured to receive a speech input from the user and produce an audio or haptic feedback for the user to convey the navigation instructions during the user's movement along the determined navigational path. The navigation instructions may offer precise, step-by-step audio instructions to guide the user to specific locations within the environment (e.g., turn left and walk 10 steps to reach the conference room).

For example, navigation instructions may include haptic or audible instructions. Examples of navigation instructions that may be provided may include: turn-by-turn directions (e.g., specific directions such as a left turn at the next intersection), distance and direction (e.g., informing the user of how far the user needs to travel before the next turn or action, and in which direction), landmark-based guidance (e.g., using recognizable landmarks or point of interests (POIs) as reference points, such as pass the cafeteria on your left), and warnings and alerts (e.g., notifying the user about upcoming changes like traffic conditions, closed paths, or other obstacles).

In an exemplary implementation, the method may include receiving, by the at least one processor 104, the feedback from the user in response to the navigation instructions provided via the application. The feedback may include asking the user to provide inputs on the navigation instructions (for example, good or bad or any suggestions). This way, the feedback may be used to train the system to provide the best possible and accurate navigation instructions to the user.

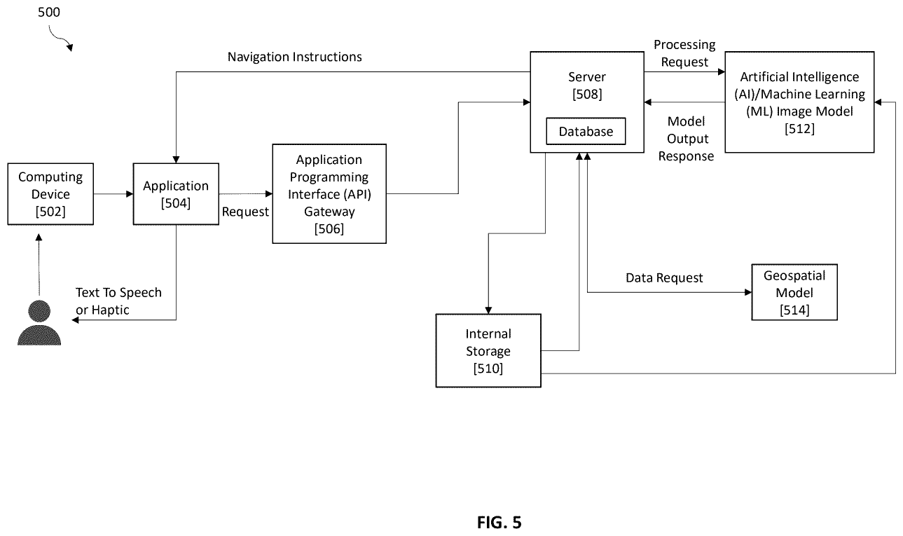

FIG. 5 illustrates an architecture of a system to assist user navigation within an environment, in accordance with an exemplary implementation. As illustrated in FIG. 5, the process flow 500 begins with receiving image data that includes images captured via a camera unit (e.g., a 360-degree camera) in response to a navigation request raised from a user via an application 504. The camera unit may be detachably coupled with a computing device 502 to capture images during the movement of the user within an environment. The computing device 502 may be associated with the user. In an example, the 360-degree camera may be coupled with an identification (ID) card worn by the user. It may be noted that environmental data including at least a blueprint of the environment, and the latest images of the environment may be received before reception of the image data.

Further, the captured images may be transferred to the application 504 (e.g., the mobile application 504 installed in a user device) via a Bluetooth or a wireless fidelity (Wi-Fi) technology. Further, the captured images may be transmitted to a server 508 (e.g., a cloud server) via an application programming interface (API) gateway 506 for processing the captured images. Further, the captured images may be uploaded to an internal storage 510 (also referred to as a database) by the application 504. The internal storage 510 may store blueprints or layouts of an environment or office. The internal storage 510 may be used to provide input data to the server 508 for providing navigation assistance to the user in response to the navigation request received from the user.

Further, the application 504 communicates with an artificial intelligence (AI)/machine learning (ML) image model 512 via the server 508. It may be noted that, the AI/ML image model 512 may be created and trained using different combinations of images associated with the environment. Further, the image data and the environmental data may be loaded into the AI/ML image model 512 hosted on an internal office network. For example, the AI/ML model may be loaded with images captured via the computing device 502 and a plurality of images captured from pre-installed cameras in the environment (e.g., an office or a building). Further, the present disclosure feeds such images to the AI/ML image model 512 hosted on an internal network to train and optimize the AI/ML image model 512. Further, the server 508 may be connected with a geospatial model 514. The geospatial model 514 may be created based on sensor data received from a plurality of sensors. The geospatial model 514 may receive a collection of spatial coordinates with at least one meter (1M) radius for each point of interest (POI) label. All the spatial coordinates may be stored in the AI/ML image model 512. The geospatial model 514 may be trained using the sensor data. The sensor data may be received from at least one of the plurality of sensors, wherein the sensor data includes coordinates information associated with the user and the one or more obstacles detected during the movement of the user from the source point to the destination point. For example, a wireless fidelity (Wi-Fi) positioning system may be utilized for detecting objects (or obstacles) and determining the location coordinates. The geospatial model 514 may utilize Kalman filters and/or particle filters. These filters may commonly be used for sensor fusion to integrate data from the plurality of sensors.

In an exemplary implementation, real-time model optimization may be performed using a feed of the image data captured by a minimal group of users from the environment (e.g., each building or office of such environment) via their associated computing devices. The models 512 and 514 may be designed in a way that the models have the capability for self-training using the real-time data. Upon completion of training of the models, the server 508 may automatically apply a convolutional neural network (CNN) algorithm to reduce storage and computational costs by eliminating unnecessary data, streamlining data management, ensuring compliance, and ultimately optimizing resource utilization. CNNs may be highly effective for tasks like object detection, image classification, and semantic segmentation, making them suitable for identifying landmarks, obstacles, doorways, and signage in the environment.

Further, the AI/ML image model 512 provides an output response (e.g., a model output response) to the server 508 in response to the navigation request. The server 508 determines a route from a user location (also referred to as a source point) to a destination point by finding a navigational path. The navigational path may be identified based on a result of a comparison of the environmental data with the image data, the source point, and the destination point. Further, the server 508 provides, to the application 504 via the API gateway 506, navigation instructions to the user device to assist the user to navigate to the destination point in response to a user movement along the route. The AI/ML image model 512 and the geospatial model 514 may utilize algorithms for pathfinding and may be employed to find the optimal path from the user's current location to their desired destination while considering factors like distance, accessibility, and user preferences. The navigation instructions may be provided to the user in the form of audio commands or haptic feedback through the application 504. It may be noted that, through intuitive user interfaces and tactile feedback systems, the user may interact with the system, to receive auditory guidance and tactile feedback. The application 504 may allow the user to enable customization of alert types and sensitivity levels for the navigation instructions as per the user's convenience.

It will be appreciated by the person skilled in the art that the disclosed method offers a full-circle, adaptable, and intelligent solution for implementing a method to assist the user navigation within an environment. The present disclosure uses a plurality of image processing techniques and models to provide navigation guidance for visually impaired people or an individual in an environment or indoor conditions.

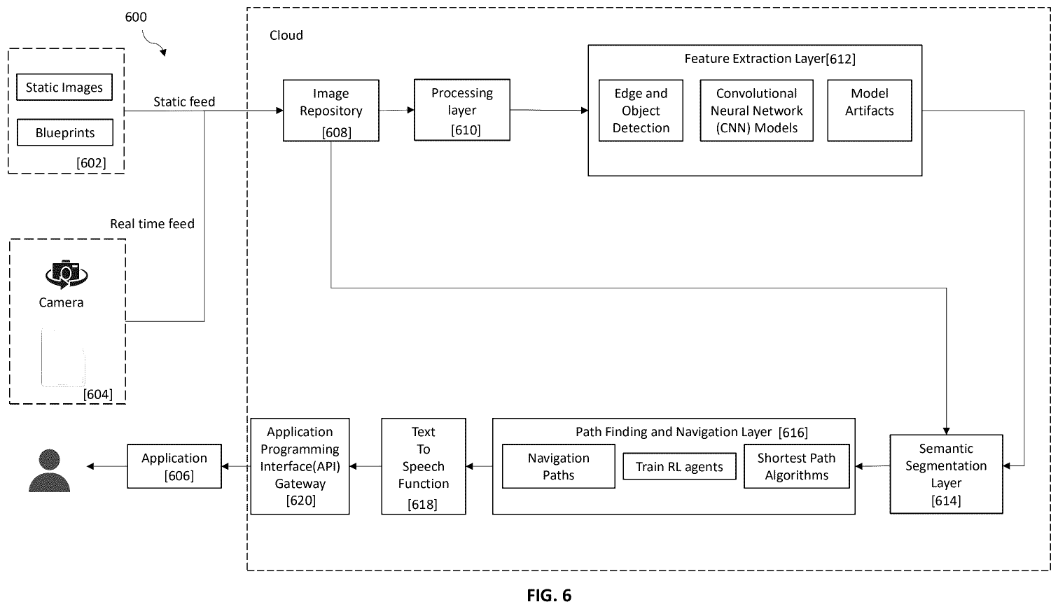

FIG. 6 illustrates an architecture of a system depicting cloud-based image processing, in accordance with an exemplary implementation. As illustrated in FIG. 6, the process flow 600 begins with receiving a first feed 602 of static images and blueprints or layouts of an environment (e.g., a building or an office) in an image repository 608. The image repository 608 may be a cloud-based image repository 608. The image repository 608 may also receive a second feed 604 of real-time images captured via a camera (e.g., a 360-degree camera) associated with a user device (e.g., a portable device) during the movement of the user within the environment. The user device may be associated with the user (or carried by the user). Additionally, the system or user device may collect sensor data in real-time during the movement of the user within the environment, in response to the navigation request. The sensor data may be received from at least one of a plurality of sensors. The sensor data may include coordinates information associated with the user and the obstacle(s) detected during the movement of the user from the source point to the destination point. The plurality of sensors may include at least one from among a light detection and ranging (LiDAR) sensor, an ultrasonic sensor, a camera sensor, a microphone sensor, an accelerometer sensor, a gyroscope sensor, and a proximity sensor.

Further, the first feed 602 and the second feed 604 may be transferred to an application 606 (e.g., the application 606 installed in the user device) via a Bluetooth or a wireless fidelity (Wi-Fi) technology. Further, the user device may send the first feed and the second feed to an application programming interface (API) gateway 620 via the application 606.

Further, the image repository 608 may transmit images received from the first feed 602 and the second feed 604 to a pre-processing module (also referred to as processing layer) 610 for processing the images, in response to the navigation request. The pre-processing layer 610 may then perform image enhancement, blurring of human images, and/or binarization of images as a part of processing. It may be noted that pre-processed images may be stored into the pre-processing layer 610. Further, features may be extracted from such pre-processed images in a feature extraction layer 612. The feature extraction layer 612 may identify edges and objects from the pre-processed images using at least one function (e.g., a lambda function) with an open-source computer vision library (OpenCV®) for edge detection and a tenser flow or pytorch model for the object detection. The feature extraction layer 612 may further utilize machine learning algorithms or a platform (e.g., a sage maker) to host and run pre-trained convolutional neural network (CNN) models on the pre-processed images for feature extraction. Further, a semantic segmentation layer 614 may be used to refine features obtained at the feature extraction layer 612 by using the real-time feed of images and features extracted from the feature extraction layer 612. For example, the sage maker hosts may run deep learning models like U-Net or mask region-based convolutional neural network (R-CNN) and the lambda. Further, a path finding and navigation layer 616 may receive the segmented images from the semantic segmentation layer 614. At first, the path finding and navigation layer 616 may utilize the lambda to convert segmented images to a graph representation and find the shortest path using shortest path algorithms (e.g., A* search or Dijkstra). The path finding and navigation layer 616 may train reinforcement learning agents for dynamic navigation and storing navigation data in a database. Further, a text-to-speech (TTS) function 618 (e.g., a lambda function) may convert written text provided by the navigation layer into spoken voice output. It may be used in various applications to provide auditory access to text-based content, such as screen readers for the visually impaired, virtual assistants, and automated customer service systems. The TTS function 618 may transmit spoken voice output to the application 606 via an application programming (API) gateway 620 in order to provide real-time navigation instructions to the user in response to a user movement along the suggested shortest path provided by the path finding and navigation layer 616. The navigation instructions may be provided to the user in the form of audio commands or haptic feedback through the application 606. It may be noted that, through intuitive user interfaces and tactile feedback systems, the user may be able to interact with the system, receiving auditory guidance and tactile feedback. The application 606 may allow the user to enable customization of alert types and sensitivity levels for the navigation instructions as per the user's convenience.

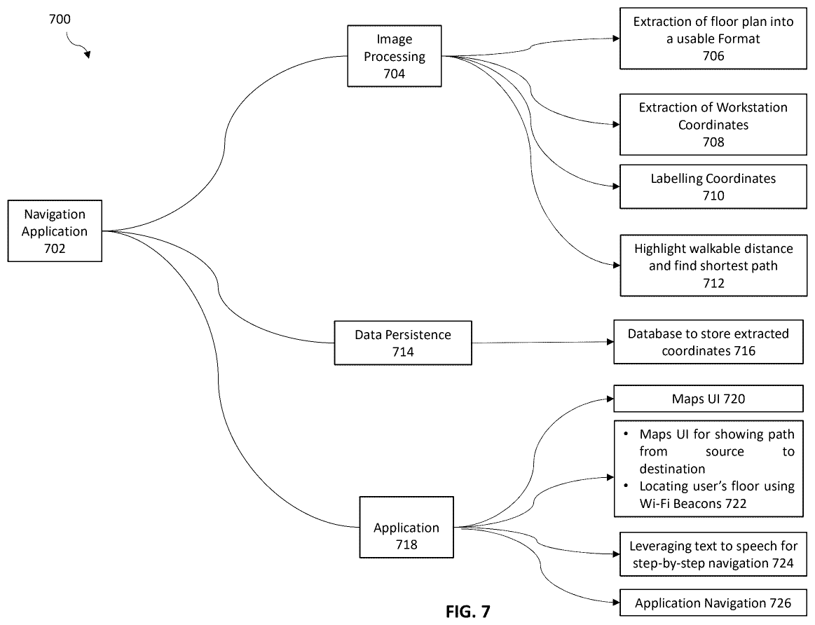

Referring to FIG. 7, an exemplary process 700 is shown which assists user navigation within an environment, in accordance with an exemplary implementation.

As shown in FIG. 7, process 700 begins following a need to provide navigation guidance or assistance for visually impaired users in order to assist them in navigating spaces such as in an office environment.

The process 700 may include a navigation application 702 which may include an image processing function 704, a data persistence function 714, an application 718 and other similar functions, which may enable the user to navigate spaces such as the office environment.

In an exemplary implementation, the navigation application 702 may use the image processing function 704 to process structural layouts stored in a database in order to identify floor plans/layouts of the office environment, wherein the structural layouts may be stored in the database in portable document format (PDF) format. The floor plans/layouts may be extracted by converting the stored PDFs into images using pymupdf library which enables visual previews of the PDF documents. As used herein, pymupdf library may refer to a high-performance Python® library designed for working with PDF documents that facilitates conversion of PDF documents to images. The image processing function 704 may then extract floor plans 706 from the images using open-source computer vision library such as, OpenCV®, which may enable extraction of structural elements that may include walls, meeting rooms, desks, doors, windows and other similar structural elements, from the image of the floor plan.

The navigation application 702 may further use the image processing 704 function to extract workstation coordinates 708. For extracting workstation coordinates, the image processing function 704 may perform template matching to extract workstation and conference coordinates.

The navigation application 702 may further use the image processing 704 function for labelling coordinates 710 with respective desk numbers and meeting room identifiers. The image processing function 704 may further include scripting to add labels to coordinate regions.

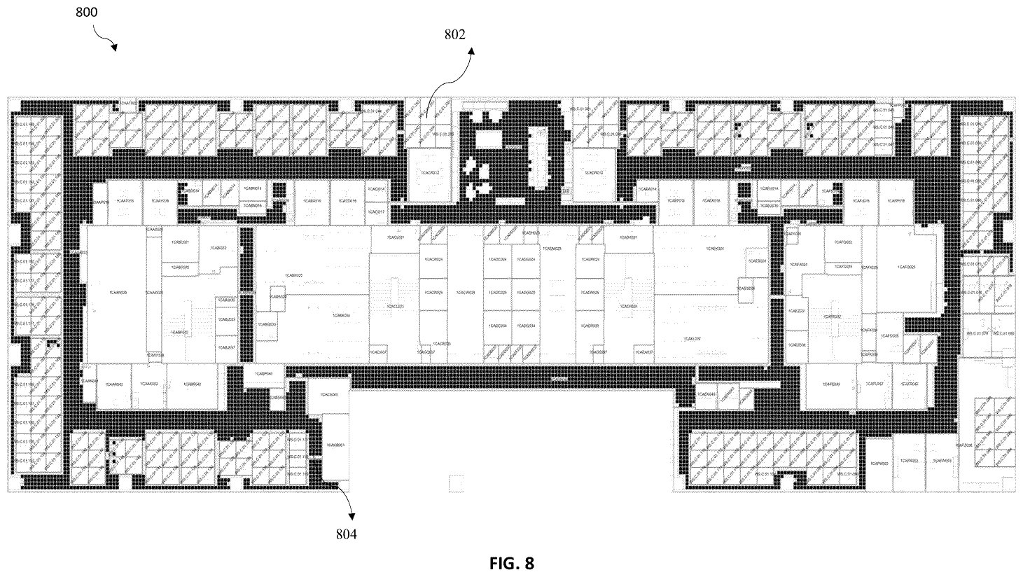

The navigation application 702 may also use the image processing function 704 to highlight walkable paths on a floor plan 712. The highlighted walkable floor paths (as shown in FIG. 8) may help find a shortest path for the user to navigate in the office environment. In an exemplary implementation, in order to highlight walkable paths, the image processing function 704 may identify free space with black color and blocked space with white color using OpenCV®. Using OpenCV® helps turn the floor plan into a black-and-white map where empty walkable areas may be represented in black and obstacles like walls or furniture may be represented in white. By inverting the image, the system may clearly see which parts may be free space and which parts may be blocked, making it much easier to plan and trace a path between source and destination. In an alternate exemplary implementation, the image processing function 704 may use an A* algorithm, to find the shortest path between the source and the destination. As used herein, the A* algorithm may refer to a pathfinding and graph traversal algorithm in computer science and artificial intelligence which may be used to find the shortest path from a starting node to a target node within a graph or grid.

The navigation application 702 may further store the processed floor plans/layouts using the data persistence function 714 to ensure data persistence, allowing the information to be retained and retrieved from the database at a later time. In an exemplary implementation, the data persistence function 714 may store the extracted workstation coordinates 716 in the database. In an exemplary implementation, a Mongo database may be used to store the extracted workstation coordinates. As used herein, the Mongo database® may refer to a NoSQL document database that stores image processing data in flexible, JSON-like documents, making it ideal for modern applications with rapidly evolving data structures.

The navigation application 702 may execute the application 718 by receiving user input specifying the source and destination on a map displayed on a Maps user interface (UI) 720 of the application 718. In an exemplary implementation, the Maps UI 720 may be a Google Maps® application. For example, a visually impaired user may use voice command or audio command, via a microphone of the user device, to input the navigation from point A to point B in the office premises on the map of the application 718. The Maps UI 720 may be developed by using an API key for a React Native® framework. As used herein, the React Native® framework is an open-source UI software framework developed by Meta Platforms®.

In an exemplary implementation, Wi-Fi beacons 722 may be used to automatically identify a floor on which the visually impaired user may be located, without requiring the visually impaired user's voice command or audio command. These Wi-Fi beacons 722 may refer to wireless transmitters strategically placed throughout office premises and may transmit Wi-Fi signals which may include unique identifiers associated with each floor, enabling the navigation application to accurately determine the visually impaired user's precise location such as specific floor level without requiring manual input such as audio or voice input, enabling accurate indoor navigation for visually impaired users. In an example, the visually impaired user may be located on the 8^{th} floor of a multi-story office building, the user's mobile device may detect Wi-Fi signals from the Wi-Fi beacons 722 placed on the 8^{th} floor and locate the visually impaired user. Similarly, the visually impaired user may be located on the 10^{th} floor of a multi-story building, the user's mobile device may detect Wi-Fi signals from the Wi-Fi beacons 722 on the 10^{th} floor and locate the visually impaired user.

The application 718 may display, on the maps UI 720, a shortest path from source to destination. In an exemplary implementation, the application 718 may display the shortest path on the map by drawing a line from source to destination using Polyline from React Native® framework. As used herein, a Polyline in React-Native® framework is a component used to draw a line or path on the map by connecting a series of geographical coordinates.

Upon displaying the shortest path on the maps UI 720, the navigation application 702 may leverage text to speech (TTS) functionality for step-by-step navigation 724. In an exemplary implementation, React Native® framework's text to speech (TTS) functionality may be used to provide auditory navigation instructions to the visually impaired users.

The application 718 may further provide an application navigation 726 feature by via a bottom tab navigator at which refers to a tab bar at the bottom of the maps UI 720 that lets the user switch between different routes.

Referring to FIG. 8, an exemplary layout 800 for identified and highlighted walkable paths (as described in FIG. 7) to assist a user navigate within an environment is shown, in accordance with an exemplary implementation. Free space 802 may be shown in black, while blocked areas such as walls or furniture 804 may be shown in white, using OpenCV®. By inverting the image, the user may easily distinguish between accessible and blocked regions, simplifying the task of planning and tracing a path from source to destination.

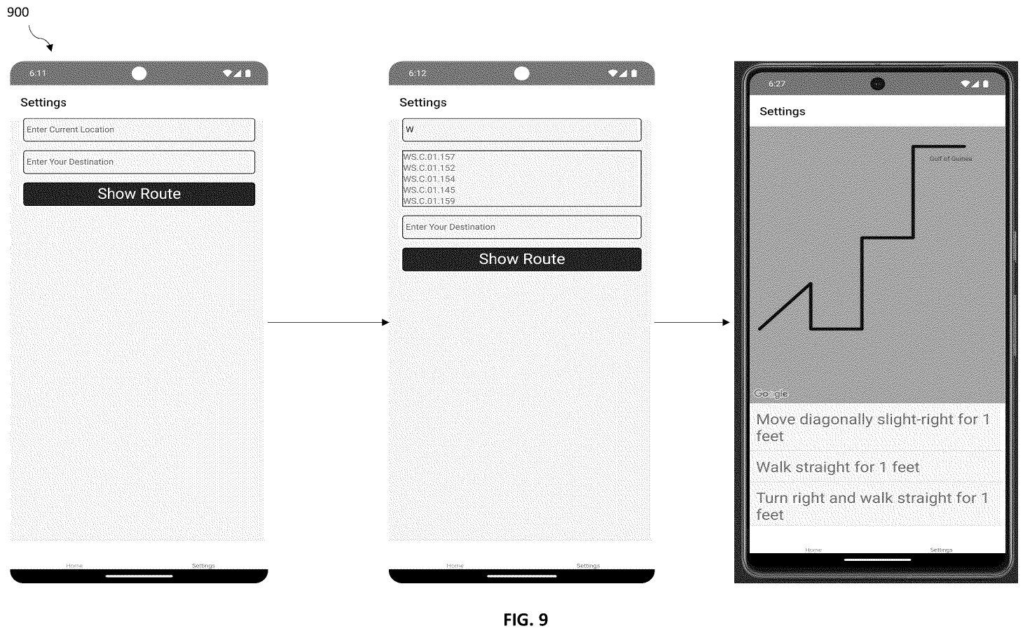

Referring to FIG. 9, an exemplary user interface 900 of a navigation application depicting navigation inside the office environment is shown, in accordance with an exemplary implementation.

As shown in FIG. 9, the user may input a current location of the user using voice commands in a search bar. In an exemplary implementation, the navigation application may automatically detect the current location of the user in the office premises. The user may then use voice commands to input a destination location manually. In an exemplary implementation, Wi-Fi beacons may be used to automatically identify a floor on which the visually impaired user may be located. These Wi-Fi beacons may refer to wireless transmitters strategically placed throughout office premises and may transmit Wi-Fi signals which may include unique identifiers associated with each floor, enabling the navigation application to accurately determine the user's precise location such as specific floor level without requiring manual input such as voice or audio or audio input, enabling accurate indoor navigation for the visually impaired users. In another exemplary implementation, the visually impaired user may use voice command or audio command, via a microphone of the user device, to input the navigation from current location to the destination location in the office premises.

Upon inputting the current location and the destination location, the navigation application shows the shortest walkable path and provides the navigation instructions to the user in the form of audio commands or haptic feedback through the navigation application. In an exemplary implementation, the shortest walkable path may be blocked due to some reason, then the navigation application may show a different walkable path enabling the visually impaired user to easily navigate within the office premises. In this way, through intuitive user interfaces and tactile feedback systems, the user may be able to interact with the application, receiving auditory guidance and tactile feedback.

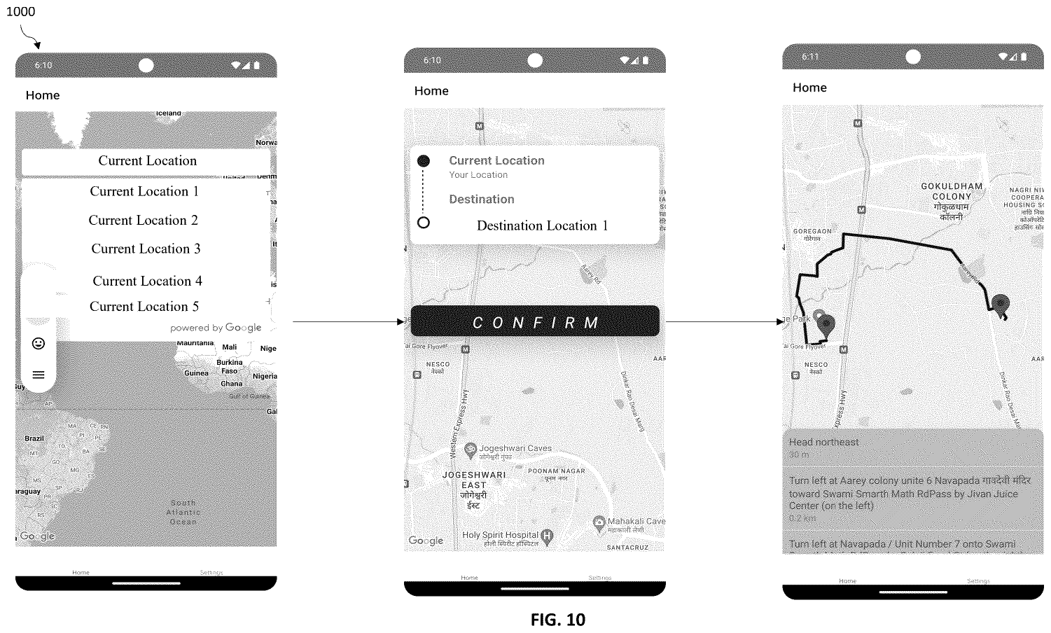

Referring to FIG. 10, an exemplary user interface 1000 of a navigation application depicting navigation outside the office environment is shown, in accordance with an exemplary implementation.

As shown in FIG. 10, the user may input current location of the user using voice commands manually in a search bar. The navigation application may automatically detect the current location of the user outside the office premises. The user may then input using voice commands a destination location manually. For example, a visually impaired user may use voice command or audio command, via a microphone of the user device, to input the navigation from current location to the destination location in the office premises.

Upon inputting the current location and the destination location, the navigation application shows the shortest walkable path and provides the navigation instructions to the user in the form of audio commands or haptic feedback through the navigation application. In this way, through intuitive user interfaces and tactile feedback systems, the user may be able to interact with the application, receiving auditory guidance and tactile feedback.

The present disclosure provides numerous advantages as given below. The present disclosure provides a method for providing navigation guidance for visually impaired individuals. The method delivers navigation instructions primarily through auditory cues or tactile feedback, making it accessible to individuals who rely on non-visual senses for navigation. This approach ensures that visually impaired users can receive clear and actionable guidance in real time. The present disclosure provides detailed navigation instructions including the surroundings, such as landmarks, pathways, and points of interest (POIs). This feature helps visually impaired individuals build a mental map of their environment and navigate with greater confidence. The user interface disclosed in the present disclosure may be designed to be accessible and user-friendly, accommodating the needs of visually impaired individuals. This includes options for customizable settings, such as voice speed or verbosity levels, to cater to varying preferences and abilities. The present disclosure assists sighted employees by providing innovative ways to familiarize them with new office layouts. The present disclosure also reduces manual guidance, which saves maintenance costs and administrative overhead. The present disclosure creates a more efficient, secure, and employee-friendly workplace, ultimately driving better business outcomes.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims. For instance, the invention has been described with reference to an indoor or office environment; however, the invention is not intended to be limited to indoor environments and may also be implemented in outdoor environments.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to assist user navigation within an environment is disclosed. The instructions include executable code which, when executed by a processor 104, may cause the processor 104 to receive environmental data including at least a blueprint of the environment, and latest images of the environment; receive a navigation request from a user, the navigation request including a source point and a destination point within the environment; collect image data and sensor data in real-time during a movement of the user within the environment, in response to the navigation request; analyze, using a machine learning-based trained model, at least the environmental data, the image data, the sensor data, the source point, and the destination point to determine a navigational path to navigate the user from the source point to the destination point, and detect one or more obstacles in the navigational path; and provide navigation instructions to the user to assist the user in navigating to the destination point, the navigation instructions being provided based on the determined navigational path and the one or more obstacles detected in the navigational path.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for assisting user navigation within an environment, the method being implemented by at least one processor, the method comprising:
receiving, by the at least one processor, environmental data comprising at least a blueprint of the environment, and latest images of the environment;
receiving, by the at least one processor, a navigation request from a user, the navigation request comprising a source point and a destination point within the environment;
collecting, by the at least one processor, image data and sensor data in real-time during a movement of the user within the environment, in response to the navigation request;
analyzing, by the at least one processor using a machine learning-based trained model, at least the environmental data, the image data, the sensor data, the source point, and the destination point to:
determine a navigational path for navigating the user from the source point to the destination point; and
detect at least one obstacle in the navigational path; and
providing, by the at least one processor, navigation instructions to the user to assist the user in navigating to the destination point, the navigation instructions being provided based on the determined navigational path and the at least one obstacle detected in the navigational path.

2. The method as claimed in claim 1, wherein the image data comprises a plurality of images of the environment captured, via a camera, in the real-time during the movement of the user from the source point to the destination point.

3. The method as claimed in claim 1, wherein the sensor data comprises coordinates information associated with the user and the at least one obstacle detected during the movement of the user from the source point to the destination point.

4. The method as claimed in claim 1, wherein the sensor data is received from at least one from among a plurality of sensors, wherein the plurality of sensors comprises at least one from among a light detection and ranging (LiDAR) sensor, an ultrasonic sensor, a camera sensor, a microphone sensor, an accelerometer sensor, a gyroscope sensor, and a proximity sensor.

5. The method as claimed in claim 1, wherein to determine the navigational path, the method further comprises:
comparing, by the at least one processor, the environmental data with the image data, the source point, and the destination point; and
determining, by the at least one processor, the navigational path based on a result of the comparing of the environmental data with the image data, the source point, and the destination point.

6. The method as claimed in claim 1, wherein the machine learning-based trained model is trained using the environmental data to:
recognize a plurality of objects in the environment;
identify a plurality of location areas in the environment; and
identify a plurality of potential navigational paths between at least one potential source point and at least one potential destination point in the environment.

7. The method as claimed in claim 1, wherein the navigation instructions are provided to the user via audio commands.

8. A computing device for assisting user navigation within an environment, the computing device comprising:
a processor;
a memory storing instructions; and
a communication interface coupled to each of the processor and the memory,
wherein the processor is configured to cooperate with the instructions to perform operations comprising:
receiving environmental data comprising at least a blueprint of the environment, and latest images of the environment;
receiving a navigation request from a user, the navigation request comprising a source point and a destination point within the environment;
collecting image data and sensor data in real-time during a movement of the user within the environment, in response to the navigation request;
analyxing, using a machine learning-based trained model, at least the environmental data, the image data, the sensor data, the source point, and the destination point to:
determine a navigational path for navigating the user from the source point to the destination point, and
detect at least one obstacle in the navigational path; and
providing navigation instructions to the user to assist the user in navigating to the destination point, the navigation instructions being provided based on the determined navigational path and the at least one obstacle detected in the navigational path.

9. The computing device as claimed in claim 8, wherein the image data comprises a plurality of images of the environment captured, via a camera, in the real-time during the movement of the user from the source point to the destination point.

10. The computing device as claimed in claim 8, wherein the sensor data comprises coordinates information associated with the user and the at least one obstacle detected during the movement of the user from the source point to the destination point.

11. The computing device as claimed in claim 8, wherein the sensor data is received from at least one from among a plurality of sensors, wherein the plurality of sensors comprises at least one from among a light detection and ranging (LiDAR) sensor, an ultrasonic sensor, a camera sensor, a microphone sensor, an accelerometer sensor, a gyroscope sensor, and a proximity sensor.

12. The computing device as claimed in claim 8, wherein to determine the navigational path, the processor is further configured to cooperate with the instructions to perform operations comprising:
comparing the environmental data with the image data, the source point, and the destination point; and
determining the navigational path based on a result of the comparing of the environmental data with the image data, the source point, and the destination point.

13. The computing device as claimed in claim 8, wherein the machine learning-based trained model is trained using the environmental data to:
recognize a plurality of objects in the environment;
identify a plurality of location areas in the environment; and
identify a plurality of potential navigational paths between at least one potential source point and at least one potential destination point in the environment.

14. The computing device as claimed in claim 8, wherein the navigation instructions are provided to the user via audio commands.

15. A non-transitory computer readable storage medium storing instructions for assisting user navigation within an environment, the instructions comprising executable code which, when executed by a processor, causes the processor to perform operations comprising:
receiving environmental data comprising at least a blueprint of the environment, and latest images of the environment;
receiving a navigation request from a user, the navigation request comprising a source point and a destination point within the environment;
collecting image data and sensor data in real-time during a movement of the user within the environment, in response to the navigation request;
analyzing, using a machine learning-based trained model, at least the environmental data, the image data, the sensor data, the source point, and the destination point to:
determine a navigational path for navigating the user from the source point to the destination point, and
detect at least one obstacle in the navigational path; and
providing navigation instructions to the user to assist the user in navigating from the source point to the destination point, the navigation instructions being provided based on the determined navigational path and the at least one obstacle detected in the navigational path.

16. The non-transitory computer readable storage medium as claimed in claim 15, wherein the image data comprises a plurality of images of the environment captured, via a camera, in the real-time during the movement of the user from the source point to the destination point.

17. The non-transitory computer readable storage medium as claimed in claim 15, wherein the sensor data comprises coordinates information associated with the user and the at least one obstacle detected during the movement of the user from the source point to the destination point.

18. The non-transitory computer readable storage medium as claimed in claim 15, wherein the sensor data is received from at least one from among a plurality of sensors, wherein the plurality of sensors comprises at least one from among a light detection and ranging (LiDAR) sensor, an ultrasonic sensor, a camera sensor, a microphone sensor, an accelerometer sensor, a gyroscope sensor, and a proximity sensor.

19. The non-transitory computer readable storage medium as claimed in claim 15, wherein to determine the navigational path, the operations further comprise:
comparing the environmental data with the image data, the source point, and the destination point; and
determining the navigational path based on a result of the comparing of the environmental data with the image data, the source point, and the destination point.

20. The non-transitory computer readable storage medium as claimed in claim 15, wherein the machine learning-based trained model is trained using the environmental data to:
recognize a plurality of objects in the environment;
identify a plurality of location areas in the environment; and
identify a plurality of potential navigational paths between at least one potential source point and at least one potential destination point in the environment.
